(19) United States
(12) Patent Application Publication
(10) Pub. No.: US 2005/0076833 A1
(43) Pub. Date: Apr. 14, 2005

(54) Paint-shield label

(76) Inventors: Dietmar Wechselberger, Furstenfeldbruck (DE); Roland Grotzner, Unterschleissheim (DE)

Correspondence Address: WILLIAM COLLARD;COLLARD & ROE, P.C., 1077 NORTHERN BOULEVARD, ROSLYN, NY, 11576, US

(21) Appl. No.: 10/502,870

(22) PCT Filed: Jan. 27, 2003
(86) PCT No.: PCT/EP03/00801

(30) Foreign Application Priority Data
Jan. 28, 2002 (DE) 102 03 235.1

(51) Int. Cl. B32B 9/00

(52) U.S. Cl. 118/505; 428/40.1

(57) ABSTRACT

While in typical enamel protection labels, an adhesive layer lies on each silicone-containing separating layer, from which the first is detachable, according to the present invention the separating area is implemented using a material pairing free of adhesive and silicone.

The enamel protection label has two masking layers (7a, 7b), more masking layers are also possible. The upper masking layer (7b) is attached using an adhesive layer (10b) onto the separating layer (8b) made of transparent UV-cured screenprint enamel. This enamel is applied to the lower masking layer (7a), made of a plastic film which is not pretreated further. The separating area (9b) functionally assigned to the upper masking layer (7b) represents the boundary area between separating area (8b) and lower masking layer (7a), along which the detachment for removing the upper masking layer (7b) is performed. After the upper masking layer (7b) is removed, the imprint (2) is visible through the lower masking layer (7a), which lies protected under the masking layer (7) during the first enameling step, and the sealing layer (6). The position and function of the initially remaining lower masking layer (7a), adhesive layer (10a), separating layer (8a), and separating area (9a) functionally assigned to the lower masking layer (7a) during and after the second enameling step are analogous.

The present invention relates to an enamel protection label, in particular an enamel protection label for covering text, image, and/or code information in an enameling process, which has a transparent sealing layer, a self-adhesive coating positioned underneath the sealing layer, and at least one removable masking layer, which covers the sealing layer at least in the region of the text, image, and/or code information and is transparent at least in the region of the coverage of the text, image, and/or code information, a separating area of two layers lying on top of one another being functionally assigned to each masking layer in such a way that these layers lying on top of one another are separated from one another when the masking layer is removed.

A label construction of this type for enamel protection applications in motor vehicle construction is known from EP-A-0065766. This is a plate-shaped code carrier for application on vehicle body parts which has optically recognizable information about the type of processing of the individual part, the association to a specific motor vehicle, etc. In order that the code carrier remains undamaged and readable after each of the steps connected with a modern enameling process, such as degreasing, phosphatizing, priming, and final enameling, it is protected by multiple transparent plastic masking pieces positioned one over another. These film pieces are each individually detachable after the particular steps, so that the information on the code carrier becomes clearly visible again through the particular masking pieces remaining under the detached film piece. This is technically implemented in that the masking pieces each have a transparent adhesive layer on their bottoms and are attached therewith to a siliconized layer of the particular film lying underneath. The siliconization has an adhesive-reducing effect and is therefore responsible for the glued-on masking piece remaining detachable. During the manufacturing of the masking film composite, each plastic film must be subjected to a pretreatment before the siliconization, for example, a chemical roughening by using a primer in order to allow the siliconized layer to adhere to the particular film.

An adhesive composite of the type previously known, in which the self-adhesive individual layers detach from one another at separating layers made of silicon-containing separation enamels, is problematic in application, since, among other things, released silicone may interfere with the sensitive enameling process and cause enameling flaws. In addition, the film pretreatment typically necessary for the siliconization is complex and costly. In consideration of temperatures of up to 200° C. occurring during drying steps in the enameling method, different possibilities for alternative achievements of the object in the framework of the known technology of detaching an adhesive from a substrate are also problematic. Known adhesives detachable from plastic films without siliconization tend to interlock with the substrate when they are subjected to temperatures this high.

Because of the problems described, the present invention is based on the object of providing an enamel protection label of the type described at the beginning which is at least equal to typical adhesive composites in handling and functional reliability in the event of high temperature stress, but also reduces the release of silicone as much as possible.

This object is achieved according to the present invention by an enamel protection label for masking text, image, and/or code information, which represents a barcode or a part number, for example, which has a transparent sealing layer, a self-adhesive coating positioned underneath the sealing layer, and at least one removable masking layer, which covers the sealing layer at least in the region of the text, image, and/or code information and is transparent at least in the region of the coverage of the text, image, and/or code information, a separating area of two layers lying on top of one another being functionally assigned to each masking layer in such a way that these layers lying on top of one another are separated from one another when the masking layer is removed, and the separating area being adhesive-free.

While in typical enamel protection labels, the separating areas each lie between an adhesive layer and a separating layer, from which the adhesive layer is to be detachable, in the achievement of the object according to the present invention, the separating area is implemented, in a way completely surprising to those skilled in the art, using an adhesive-free material pairing. The object, which was previously only achieved in an unsatisfactory way, of designing an adhesive material layer so that it is detachable from its substrate while avoiding siliconization, even after they have been subjected to unfavorable environmental conditions, is thus bypassed.

Preferably, at the particular separating area, a transparent enamel borders a plastic film which has not been subjected to any of the typical pressure preparation treatments, whether using radiation, corona discharges, or a chemical primer. Because such a pretreatment is avoided, the adhesion of the enamel to the plastic film is limited, so that the enamel may be detached to remove the masking layer assigned to the separating area, but the coherence is sufficient that the overall composite does not fall apart at an undesired time. The plastic film may be the sealing layer in the case of the lowermost masking layer, and in the case of possible masking layers lying underneath, it may be the particular next masking layer lying underneath. The avoidance of the otherwise typical pressure preparation treatment also results in simplification and price reduction of the label manufacturing.

The enamel is preferably a UV-curing enamel. Enamels of this type are available as silicone-free or at least nearly silicone-free systems, silicone-free systems being especially advantageous in consideration of the avoidance of silicone release.

According to an especially preferred embodiment of the present invention, the enamel is applied using screen printing. A defined application thickness of the enamel may thus be set. This is particularly advantageous when the enamel layer is glued to the layer lying above it, since the adhesive may thus be reliably prevented from bleeding through to the film, so that the separating area thus remains adhesive-free according to the present invention.

According to further preferred embodiments of the present invention, the enamel is applied using the letterpress or flexographic printing methods.

Using the material pairing cited, of a suitable enamel and suitable plastic film, a bond may be provided on the separating area, in a way surprising to those skilled in the art, which offers sufficient coherence for the overall composite, but also results in the desired detachability.

According to an advantageous refinement, underneath the sealing layer, a base layer glued thereto is positioned, whose top is provided with the text, image, and/or code information to be masked. The self-adhesive coating to be stuck on the object to be enameled is then advantageously positioned on the bottom of the base layer. This base layer thus assumes the task of the vehicle identification plate or process tracking label. Instead of first attaching an information carrier on the object to be enameled and then attaching the enamel protection label thereto, these two steps may thus be combined in one procedure. This means a savings in complexity and cost in the manufacturing cycle of the part to be enameled, in particular since in the embodiment described a less precise positioning of the enamel protection label on the substrate is sometimes sufficient, while in contrast the label must otherwise be positioned so that it precisely covers the information carrier already present. The manufacture of an information carrier having enamel protection according to the present invention already integrated is sometimes more cost-effective than the separate manufacture of information carrier and enamel protection label.

If the information carrier is to be manufactured and applied independently from the enamel protection label for certain reasons, the sealing layer itself advantageously carries the self-adhesive coating on its bottom.

According to an especially preferred embodiment of the present inventions the enamel protection label has multiple masking layers positioned on top of one another, which are removable one after another. In this way, in a multistep enameling process, after each process step the transparent remaining composite lying underneath may be exposed by pulling off the uppermost contaminated, enameled, or cloudy layer for a clear view through to the masked text, image, and/or code information.

According to an advantageous refinement, each masking layer directly adjoins its particular functionally assigned separating area. In this case, adhesive layers between the masking layers and/or between the sealing layer and lowermost masking layer may be dispensed with. The masking layers are attached to one another and/or to the sealing layer using curable enamel which is cured after the application of the particular layer lying thereunder. In this case, the film area located under the enamel layer may be pressure pretreated, but not the film area of the functionally assigned masking layer lying above it. However, an adhesive layer may also be located between the enamel layer and the film area lying underneath. During manufacturing, the masking layer to which this separating area is functionally assigned is preferably first printed with UV-curing enamel using screen printing and this enamel is then cured, after which the masking layer is laminated together with the next film lying underneath, which is adhesive-coated.

According to another advantageous embodiment, each masking layer, with the exception of the uppermost masking layer, adjoins the separating area functionally assigned to the particular next masking layer lying underneath. In this case as well, adhesive layers between the masking layers and/or between the sealing layer and the lowermost masking layer may be dispensed with. The masking layers are attached to one another and/or to the sealing layer using curable enamel, which is cured after the application of the particular layer lying above it. In this case, the film area located above the enamel layer may be pressure pretreated, but not the film area of the functionally assigned masking layer lying underneath it. However, an adhesive layer may be located between the enamel layer and the film area lying underneath it. During manufacturing, the particular plastic film which is to adjoin the corresponding separating area is preferably first printed with UV-curing enamel using screen printing and this enamel is then cured, after which the adhesive-coated masking layer to which this separating area is functionally assigned is laminated over.

The label preferably has at least one removal aid functionally assigned to a particular masking layer. This may be a grip tab shaped onto the masking layer assigned to it or a separate film piece.

The individual layers do not absolutely have to be implemented over the entire area for flawless functioning of the enamel protection label. Particularly in the edge regions, the construction may be altered in order to obtain local regions of increased or reduced adhesion when this is expedient. For example, it is especially favorable in the case of adhesive layers positioned between the masking layers to dispense with a separating layer in a narrow region adjoining a provided removal aid, so that there is increased local adhesion between the masking layer assigned to the separating layer and the particular film composite lying underneath it. This measure may help avoid premature undesired detachment of the corresponding masking layer through mechanical effects during the enameling process.

Examples of preferred embodiments of the present invention will be explained in greater detail on the basis of the associated figures. The illustrations selected are sectional illustrations which are not to scale and are to be seen as purely schematic in this case. In particular, the layer thicknesses are greatly enlarged for reasons of viewability.

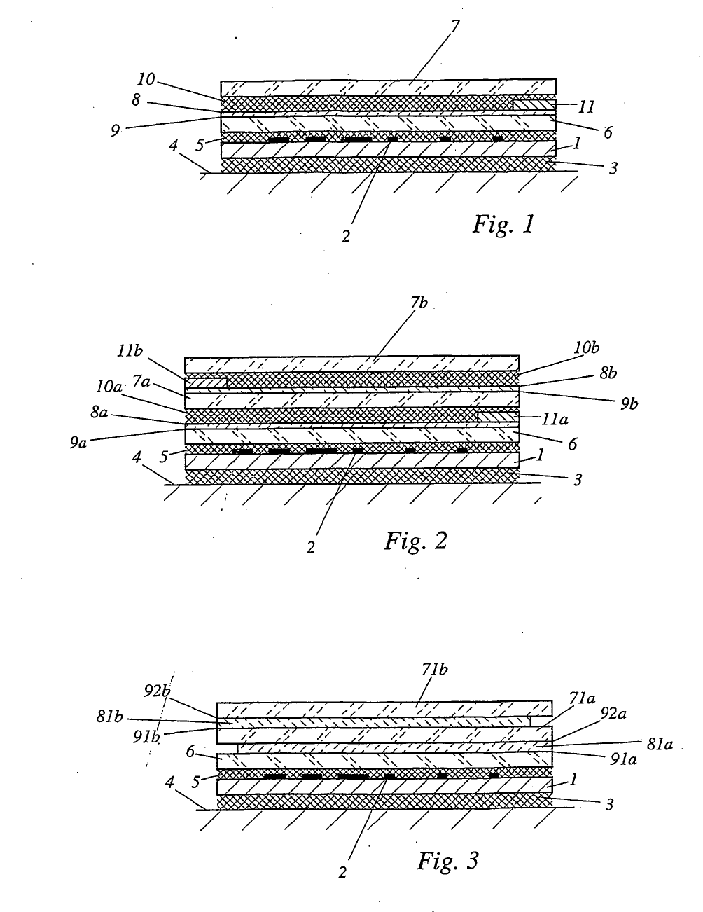

FIG. 1 shows an enamel protection label according to the present invention attached to a substrate, having a masking layer which is laminated onto an enamel layer using an adhesive,

FIG. 2 shows a label arrangement according to the present invention having two masking layers detachable independently from one another, each of which is laminated onto an enamel layer using an adhesive,

FIG. 3 shows a label arrangement according to the present invention having two masking layers detachable independently from one another, which are attached to the particular layer lying underneath without using adhesive.

In all of the figures, an information carrier 1 printed with optically viewable information 2 (text, numbers, a barcode, or something similar) is illustrated, which is attached using an adhesive layer 3 onto a surface 4, of a vehicle body part of a motor vehicle, for example, which is to be subjected to an enameling treatment. The information carrier 1 may either be a part of the enamel protection label as a printed base layer and be attached therewith to the surface 4, or it may be a vehicle identification plate or the like which is manufactured separately and applied to the surface 4 before, the enamel protection label is attached. Using the transparent adhesive layer 5, the sealing layer 6, which is also transparent, is attached to the information carrier 1. If the information carrier 1 is not part of the enamel protection label, the adhesive layer 5 is implemented as a pressure-sensitive adhesive coating and is covered with removal material before the enamel protection label is stuck on.

The label illustrated in FIG. 1 is equipped with a single masking layer 7, which is made of transparent plastic film. This masking layer is attached using an adhesive layer 10 to the separating layer 8, which is made of a transparent UV-cured screenprint enamel. This enamel is applied using screen printing onto the sealing layer, made of a plastic film which is not pretreated using primer, corona discharge, or the like for the printing. The separating area 9 represents the boundary surface between the separating layer 8 and the sealing layer 6, along which the detachment for removing the masking layer 7 is performed when the enameling procedure has ended. The separating layer 8 is therefore removed together with the masking layer 7. After the masking layer 7 is removed, the imprint 2 is visible through the sealing layer 6, which lies protected under the masking layer 7 during the enameling. The removal is made easier by the film piece 11, which does not adhere to the separating layer 8, so that the masking layer 7 may be grasped easily at this position.

During manufacturing, the masking layer 7, which is provided with the adhesive layer 10, is laminated over the sealing layer 6 printed with the separating layer 8.

The label illustrated in FIG. 2 has two masking layers 7a, 7b and is therefore especially suitable for use in two-stage enameling methods, such as double-layer enameling without further pretreatment or single-layer enameling with priming. Analogously constructed enamel protection labels having three or more masking layers are also possible without problems. The upper masking layer 7b is attached using an adhesive layer 10b onto the separating layer 8b, which is made of transparent UV-cured screenprint enamel. This enamel is applied using screen printing onto the lower masking layer 7a, made of a plastic film which is not pretreated using primer, corona discharge, or the like for the printing. The separating area 9b functionally assigned to the upper masking layer 7b represents the boundary surface between the separating layer 8b and the lower masking layer 7a, along which the detachment for removing the upper masking layer 7b is performed when the enameling procedure has ended. The separating layer 8b is therefore removed together with the upper masking layer 7b. After the upper masking layer 7b is removed, the imprint 2 is visible through the lower masking layer 7a, which lies protected under the masking layer 7 during the enameling, and the sealing layer 6. The position and function of the lower masking layer 7a, adhesive layer 10a, separating layer 8a, and separating area 9a functionally assigned to the lower masking layer 7a remaining after the first method step during and after the second step of the enameling method is completely analogous to the embodiment described with reference to FIG. 1 and therefore will not be described again separately at this point.

A film piece 11a, 11b, which is used as a removal aid in the way described above, is assigned to each masking layer 7a, 7b.

The label illustrated in FIG. 3 again has two transparent plastic masking layers 71a, 71b and is therefore suitable for two-step enameling methods. In this case as well, analogously constructed variations having multiple masking layers for enameling processes having multiple steps may be implemented without problems. The upper masking layer 71b is applied directly to the lower masking layer 71a using the transparent UV-cured enamel layer 81b. The lower masking layer 71a is also applied directly to the sealing layer 6 using the transparent UV-cured enamel layer 81a. During manufacturing, each enamel layer 81a, 81b is first printed on one of the layers which it connects, and then the particular other layer connected by this enamel layer is applied and the enamel is subsequently cured under the effect of ultraviolet light.

Either the boundary area 92b between upper masking layer 71b and enamel layer 81b or the boundary area 91b between enamel layer 81b and lower masking layer 71a may be functionally assigned to the upper masking layer 71b as the separating area. In the first case, the bottom of the upper masking layer 71b is not pretreated using primer or the like during manufacturing, in the second case the top of the lower masking layer 71a is not pressure pretreated using primer or the like during manufacturing. The particular other film area adjoining the enamel layer 81b may be pretreated in order to achieve better adhesion of the enamel layer 81b at this point and therefore more defined detachment behavior at the separating area 91b and/or 92b.

Either the boundary area 92a between lower masking layer 71a and enamel layer 81a or the boundary area 91a between enamel layer 81a and sealing layer 6 may be functionally assigned to the lower masking layer 71a as a separating area. In the first case, the bottom of the lower masking layer 71a is not pretreated using primer or the like during manufacturing, in the second case the top of the sealing layer 6 is not pressure pretreated using primer or the like during manufacturing. The particular other film area adjoining the enamel layer 81a may be pretreated in order to achieve better adhesion of the enamel layer 81a at this point and therefore more defined detachment behavior at the separating area 91a and/or 92a.

In the exemplary embodiment shown in FIG. 3, no separate film piece is provided as a removal aid, rather the connecting enamel layers 81a, 81b are each not implemented over the entire area, but leave edge regions exposed, at which the particular masking layer 71a, 71b lying underneath may be grasped.

The application in the enameling process is performed analogously in the embodiment shown in FIG. 3 to the exemplary embodiment explained on the basis of FIG. 2.

1. An enamel protection label for masking text, image, and/or code information (2) in an enameling process, having
a transparent sealing layer (6),
a self-adhesive coating (3) positioned underneath the sealing layer (6), and
at least one removable masking layer (7, 7a, 7b, 71a, 71b), which covers the sealing layer (6) at least in the region of the text, image, and/or code information (2) and is transparent at least in the region of the coverage of the text, image, and/or code information (2),
a separating area (9, 9a, 9b, 91a, 91b, 92a, 92b) of two layers lying on top of one another being functionally assigned to each masking layer (7, 7a, 7b, 71a, 71b) in such a way that these layers lying on top of one another are separated from one another when the masking layer (7, 7a, 7b, 71a, 71b) is removed,
wherein the separating area (9, 9a, 9b, 91a, 91b, 92a, 92b) is adhesive-free.

2. The enamel protect ion label according to claim 1, wherein one of the layers lying on top of one another at the separating area (9, 9a, 9b, 91a, 91b, 92a, 92b) is made of a transparent enamel, and the other is made of a plastic film.

3. The enamel protection label according to claim 2, wherein the enamel is a UV-cured enamel.

4. The enamel protection label according to claim 2, wherein the enamel is applied using screen printing, letterpress printing, or flexographic printing.

5. The enamel protection label according to claim 2, wherein the enamel is silicone-free.

6. The enamel protection label according to claim 1, wherein, under the sealing layer (6), a base layer (1) which is glued thereto is positioned, whose top is provided with the text, image, and/or code information (2) to be covered, and whose bottom carries the self-adhesive coating (3).

7. The enamel protection label according to claim 1, wherein the sealing layer (6) carries the self-adhesive coating (5) on its bottom.

8. The enamel protection label according to claim 1, wherein the enamel protection label has multiple masking layers (7a, 7b, 71a, 71b), which are positioned one on top of another and are removable one after another.

9. The enamel protection label according to claim 1, wherein the sealing layer (6) adjoins the separating area (9, 9a, 91a) functionally assigned to the proximate masking layer (7, 7a, 71a) lying above it.

10. The enamel protection label according to claim 1, wherein each masking layer (71a, 71b) adjoins the particular separating area (92a, 92b) functionally assigned to it.

11. The enamel protection label according to claim 9, wherein each masking layer (7a, 71a), with the exception of the uppermost masking layer (7b, 71b), adjoins the separating area (9b, 91b) functionally assigned to the particular proximate masking layer lying above it.

12. The enamel protection label according to claim 11, wherein the bottom of each masking layer (7a, 7b) adjoins one adhesive layer (10a, 10b).

13. The enamel protection label according-to claim 1, wherein the label has at least one removal aid functionally assigned to each masking layer (7, 7a, 7b, 71a, 71b).

14. The enamel protection label according to claim 13, wherein the removal aid is a grip tab shaped onto the masking layer (7, 7a, 7b, 71a, 71b) assigned thereto.

15. The enamel protection label according to claim 13, wherein the removal aid is a separate film piece (11, 11a, 11b).

16. The enamel protection label according to claim 13, wherein the removal aid is manufactured through adhesive neutralization using partial printing of an adhesive layer (10a, 10b) adjoining the bottom of the masking layer (7, 7a, 7b, 71a, 71b).

17. The enamel protection label according to claim 13, wherein a narrow region of locally increased adhesion between the masking layer functionally assigned (7, 7a, 7b, 71a, 71b) to the removal aid and the film composite lying underneath is positioned near the removal aid.
